(19) United States
(12) Patent Application Publication
(10) Pub. No.: US 2025/0349285 A1
(43) Pub. Date: Nov. 13, 2025

(54) METHOD AND APPARATUS FOR DETERMINING SPEAKER EFFECTIVENESS IN CONVERSATIONS

(71) Applicant: Uniphore Technologies, Inc., Palo Alto, CA (US)

(72) Inventors: James GIBSON, Palo Alto, CA (US); Saurabh SAXENA, Palo Alto, CA (US)

(21) Appl. No.: 18/658,135

(22) Filed: May 8, 2024

(51) Int. Cl. G10L 15/18; G10L 15/16; G10L 17/26

(52) U.S. Cl. CPC G10L 15/1815; G10L 15/16; G10L 17/26

(57) ABSTRACT

In a method and an apparatus for determining speaker effectiveness in conversations, the method includes determining a sentiment transition (ST) score in a consecutive speaker turn pair in a conversation between a first speaker and a second speaker. The ST score measures whether the sentiment transition from the first speaker to the second speaker is negative, neutral, or positive. The method further includes determining a semantic classification (SC) score in the speaker turn pair. The SC score measures the relevance of utterances of the second speaker to the utterance of the first speaker. The method further includes determining an empathy score for the second speaker in the speaker turn pair based on the ST score and the SC score.

### FIELD

The present disclosure relates generally to determination of speaker effectiveness, and particularly to determining speaker effectiveness in conversations.

### BACKGROUND

Conversations between business organizations and its customers are key to the success of business. Whether such conversations are in the context of selling products or services of the organizations, for example, between a sales representative (seller) and a customer, or in providing customer service, for example, between a customer service agent (agent) and the customer.

Conventional techniques do not allow for measuring or improving effectiveness of such conversations. In particular, conventional techniques lack concrete and objective ways for assessing the seller or the agent in the conversation, or determine what is spoken and what relates to the overall effectiveness of the conversation. Accordingly, there exists a need for techniques for determining speaker effectiveness in conversations.

### SUMMARY

The present disclosure provides a method and an apparatus for determining speaker effectiveness in conversations, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

So that the manner in which the above-recited features of the present disclosure can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram of an apparatus for determining speaker effectiveness in conversations, according to some embodiments.

FIG. 2 illustrates a flow chart for implementing a method for determining speaker effectiveness in conversations, according to some embodiments.

### DETAILED DESCRIPTION

Embodiments of the present invention relate to a method and an apparatus for determining speaker effectiveness in conversations, for example, in sales conversations between a seller and a customer, or customer service conversations between an agent and a customer. For simplicity, future reference to “seller” includes reference to agent unless otherwise apparent from context. Effectiveness of such conversations is based on an empathy demonstrated by the seller to the customer, which in turn determines the business relationship or rapport between the seller and the customer, and associated outcomes or effectiveness of the conversations. Empathy is determined mathematically by determining sentiment transition (ST) scores between the customer and the seller, and semantic classification (SC) scores between the customer and the seller. Empathy may be determined for each pair of speaker turns, or by aggregating for a group of turns, or for the entire conversations. Based on the ST and SC scores, an empathy score for the seller is determined. Various portions of the techniques may utilize Artificial Intelligence and/or Machine Learning (AI/ML) techniques, or other algorithmic techniques. The empathy score may be used for determining effectiveness of the seller, training needs for the seller, among others.

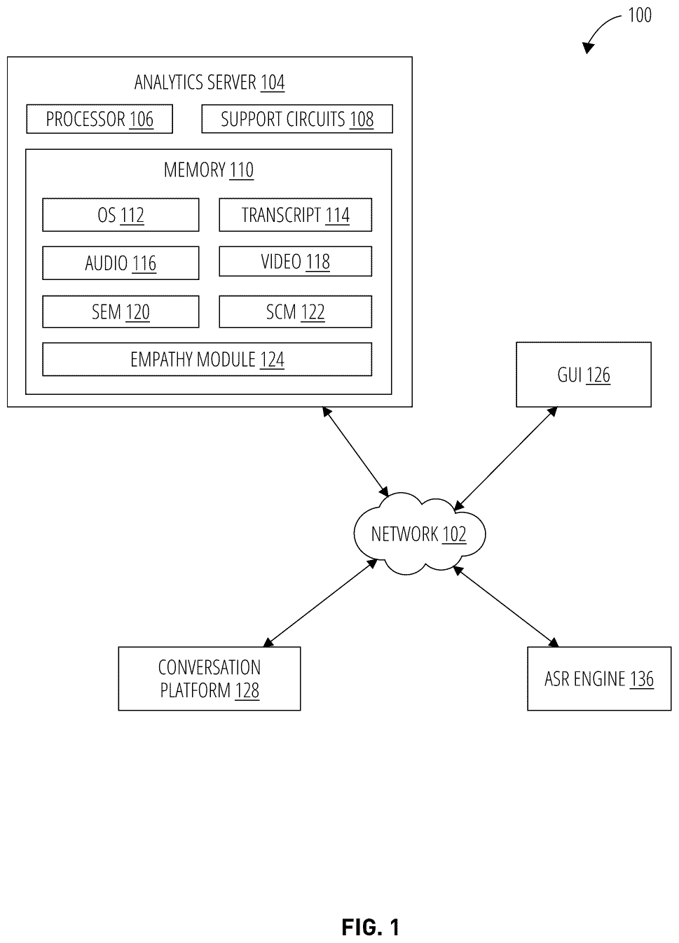

FIG. 1 illustrates a block diagram of an apparatus 100 for determining speaker effectiveness in conversations, according to some embodiments. The apparatus 100 includes a network 102 communicably coupling an analytics server 104, a Graphical User Interface (GUI) 126, for example, of a user computing device (not shown), a conversation platform 128, and an automatic speech recognition (ASR) engine 136.

The network 102 is a communication network, such as any of the several communication networks known in the art, and for example, a packet data switching network such as Internet, a proprietary network, a wireless Global System for Mobile Communication (GSM) network, among others. The network 102 is capable of communicating data to and from the analytics server 104, a graphical user interface (GUI) 126, the conversation platform 128, and the ASR engine 136.

The conversation platform 128 provides an audio 116 and/or a video 118 of a conversation to the analytics server 104. The conversation platform 128 includes a chat or a telephonic system, for example, as used in customer care centers to enable a conversation between a customer service agent and a customer, or a multimedia communication platform, such as ZOOM provided by ZOOM VIDEO COMMUNICATIONS, INC. of San Jose, CA, that enables conversations between business representatives, such as a seller, and a customer. In some embodiments, the conversation platform 128 provides live or recorded audio and/or video of the conversation between the first speaker and the second speaker to the analytics server 104, and/or the ASR engine 136. The conversations include, without limitation, sales conversations, customer service conversations, or any other conversations in which identifying speaker empathy is important to the effectiveness of the speaker in the conversation. For example, the first speaker may be a customer, and the second speaker may be a seller or an agent, and the empathy of the second speaker is evaluated.

In some embodiments, the GUI 126 is a part of the conversation platform 128. In some embodiments, the GUI 126 is comprised in a computing device which is communicably coupled to the analytics server 104 via the network 102. In some embodiments, the GUI 126 is configured to display or present empathy scores. The empathy scores are numerical or graphical representations of a level of empathy associated with the conversation, and/or the seller. The GUI 126 allows the user thereof to view and interpret the conversation based on a representation of empathy scores and related information, for example, empathy analytics, presented on the GUI 126.

In some embodiments, the ASR engine 136 is any of several commercially available or otherwise well-known ASR engines, as generally known in the art, providing ASR as a service from a cloud-based server, a proprietary ASR engine, or an ASR engine which can be developed using known techniques. The ASR engine 136 is capable of transcribing speech data (spoken words) to corresponding text data (text words or tokens) using ASR techniques, as generally known in the art, and includes a timestamp for some or each token(s). In some embodiments, the ASR engine 136 is implemented on the analytics server 104. In some embodiments, the ASR engine 136 is co-located with the analytics server 104.

In some embodiments, the analytics server 104 includes a processor 106, support circuits 108, and a memory 110. The processor 106 is communicatively coupled to the support circuits 108 and the memory 110. The processor 106 may be any commercially available processor, a microprocessor, a microcontroller, and the like. The support circuits 108 comprise well-known circuits that provide functionality to the processor 106, such as, a user interface, clock circuits, network communications, cache, power supplies, Input/Output (I/O) circuits, and the like. The memory 110 is any form of digital storage used for storing data and executable software. Such memory 110 includes, but is not limited to, a random-access memory, a read-only memory, a disk storage, an optical storage, and the like. The memory 110 includes computer readable instructions corresponding to an operating system (OS) 112, transcribed text or transcripts 114 of the conversation, audio 116 of the conversation, video 118 of the conversation, a sentiment evaluation module (SEM) 120, a semantic classification module (SCM) 122, and an empathy module 124.

The transcripts 114 are generated by the ASR engine 136 from the audio 116 of the conversation between the first speaker and the second speaker speaking via the conversation platform 128. The audio 116 is received by the ASR engine 136 from the conversation platform 128, for example, via the network 102. In some embodiments, the audio 116 and/or the video 118 is transcribed in real-time or as close to real-time as possible within the constraints of the apparatus 100, that is, while the conversation takes place between the first speaker and the second speaker. In some embodiments, conversation audios are transcribed after the calls are concluded. In some embodiments, the audio 116 and/or the video 118 is transcribed turn-by-turn, according to the flow of the conversation between the first speaker and the second speaker. The transcripts 114 comprise words or tokens corresponding to the spoken words in the audio 116 and/or the video 118, and a timestamp associated with some or all tokens.

In some embodiments, the SEM 120 is configured to determine a ST score in a consecutive speaker turn pair during the conversation between the first speaker and the second speaker. The ST score measures whether the sentiment transition from the first speaker to the second speaker is negative, neutral, or positive. In some embodiments, the SEM 120 determines sentiment for a speaker based on one or more of a transcript 114, the audio 116 (tonal data), or the video 118 (facial expression data) of the utterance of the respective speaker, using techniques known in the art. In some embodiments, the SEM 120 uses Artificial Intelligence and/or Machine Learning (AI/ML) techniques to extract one or more features such as words, phrases, and context from one or more of the transcripts 114, tonal data signals from the audio 116, or facial expression signals from the video 118 corresponding to the utterance of the speaker, and determines the sentiment based thereon. In some embodiments, the SEM 120 determines a change in the sentiment over a sequence of texts or transcripts 114 to determine the ST score. In some embodiments, the SEM 120 captures the context and sequential patterns in the conversation to determine the ST score. The ST score measures whether the sentiment transition from the first speaker (e.g., the customer) to the second speaker (e.g., the seller) is negative, neutral, or positive.

In some embodiments, the SCM 122 is configured to determine a SC score in the speaker turn pair. The SC score measures the relevance or relatedness of utterances of the second speaker to the immediately previous utterance of the first speaker. The semantic classification is performed on the transcript of each speaker turn. Semantic classification techniques include sentence correlation techniques, such as cosine of sentence embeddings, or a transformer neural network that is trained to predict an output label, given an input of the sentences of the two speakers, and other techniques known in the art. In some embodiments, if sentence of the second speaker turn is correlated strongly to the sentence of the consecutive previous turn of the first speaker, the SC score is positive, or 1; if the sentence of the second speaker turn is correlated inversely to the sentence of the consecutive previous turn of the first speaker, the SC score is negative, or −1; and otherwise, the SC score is rated as neutral or 0. In some embodiments, the SCM 122 uses a statistical model to measure relevance, relatedness, or coherence between sentences in the conversation, and determines a similarity between the sentences to assess how closely the sentences are correlated to determine the SC score.

In some embodiments, the empathy module 124 is configured to determine an empathy score for the second speaker in the speaker turn pair based on the ST score and the SC score. In some embodiments, the empathy score is determined to be high (1) if the ST score is positive (1) and the SC score is positive (1), or if the ST score is neutral (0), and the SC score is positive (1). The empathy score is determined to be neutral (0) if the ST score is positive (1), and the SC score is positive (0), or if the ST score is neutral (0) and the SC score is neutral (0), or if the ST score is negative (−1) and the SC score is positive (1). The empathy score is determined to be negative (−1) in all other scenarios, and, for example, as described in Table 1. In some embodiments, the empathy module 124 uses algorithmic techniques to determine tone, choice of words, and context to estimate a level of empathy.

Table 1 depicts an exemplary embodiment showing empathy score computation based on the ST score and the SC score.

TABLE 1

| | | Empathy |
|---|---|---|
| ST Score | SC Score | Score |
| 1 | 1 | 1 |
| 1 | 0 | 0 |
| 1 | −1 | −1 |
| 0 | 1 | 1 |
| 0 | 0 | 0 |
| 0 | −1 | −1 |
| −1 | 1 | 0 |
| −1 | 0 | −1 |
| −1 | −1 | −1 |

Other schemes for determining empathy score based on the ST score and the ST score may be arrived at within the scope of the appended claims. For example, the ST scores and the SC scores can be a fraction instead of whole numbers, associated with a higher number of states compared to the 3 states depicted by −1, 0 and 1, respectively. Similarly, the empathy score can also be computed differently to have a lower, same or higher number of states compared to the 3 states depicted by −1, 0 and 1, respectively.

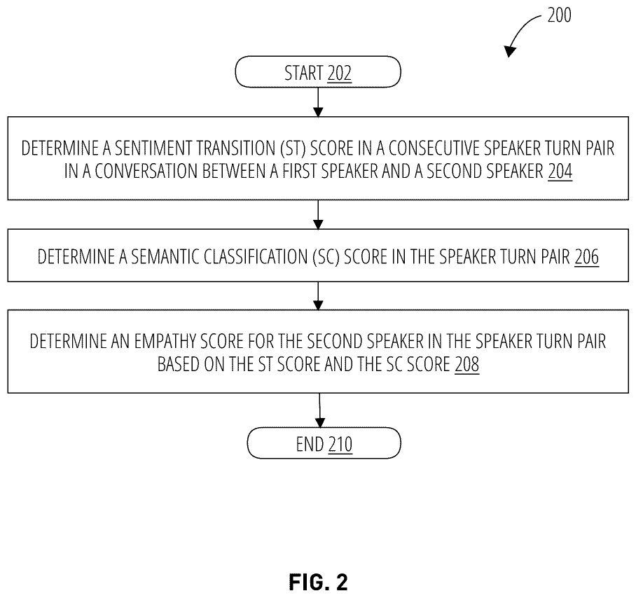

FIG. 2 illustrates a flowchart for implementing a method 200 for determining speaker effectiveness in conversations, according to some embodiments. In some embodiments, the method 200 is performed by an analytics server 104 of FIG. 1.

The method 200 starts at step 202, and proceeds to step 204, at which the method 200 determines a sentiment transition (ST) score in a consecutive speaker turn pair in a conversation between a first speaker and a second speaker. The ST score measures whether the sentiment transition from the first speaker (e.g., the customer) to the second speaker (e.g., the seller) is negative, neutral or positive. For example, the first speaker may be a seller or an agent, and the second speaker may be a customer. In some embodiments, the sentiment for a speaker is determined based on one or more of a transcript 114, the audio 116 (tonal data), or the video 118 (facial expression data) of the utterance of the respective speaker, using techniques known in the art. For example, the sentiment score for each speaker turn may be generated based on only the transcribed text for that turn using Valence aware dictionary for sentiment reasoning (VADER), TEXTBLOB, among other well-known or proprietary techniques known in the art. The sentiment score may also be generated based on one of the transcript 114, the tonal data of the audio 116, or the facial expression data of the video 118, or a fusion of two or more of the foregoing parameters. For example, the individual sentiment scores from the transcript 114 and from the tonal data of the audio 116 may be fused to yield a single, fused sentiment score for each speaker turn. In other examples, one of the sentiment scores from the transcript 114, the tonal data of the audio 116, or the facial expression data of the video 118 is selected based on the relative strength of the data, that is the strongest signal of the transcript 114, the tonal data of the audio 116, or the facial expression data of the video 118 is selected to yield the sentiment score. In some embodiments, the sentiment score is categorized as negative, neutral or positive, and may have numeral values associated as −1, 0 and 1, respectively.

In some embodiments, if the sentiment score does not change from the first speaker to the second speaker, the ST score is neutral, or 0; if the sentiment score decreases from the first speaker to the second speaker, the ST score is rated as negative or −1; and if the sentiment score increases from the first speaker to the second speaker, the ST score is rated as positive or 1. In some embodiments, the step 204 is performed by the SEM 120.

In some embodiments, the method 200 uses Artificial Intelligence and/or Machine Learning (AI/ML) techniques to determine sentiment score for speaker turns. The method 200 uses the Al/ML techniques to extract one or more features such as words, phrases, and context from one or more of the transcripts 114, tonal data signals from the audio 116, or facial expression signals from the video 118 corresponding to the utterance of a speaker, and/or determine the sentiment score based thereon. In some embodiments, the sentiment scores are determined based on algorithmic techniques, without the use of Al/ML techniques. In some embodiments, the method 200 determines the ST scores from sentiment scores for speaker turns using Al/ML techniques. In some embodiments, the ST scores are determined based on algorithmic techniques, without the use of AI/ML techniques.

At step 206, the method 200 determines a semantic classification (SC) score in a consecutive speaker turn pair in a conversation between the first speaker and the second speaker. The SC score measures the relevance, relatedness, or coherence of utterance of the second speaker to the immediately previous utterance of the first speaker. The semantic classification is performed on the transcript of each speaker turn, using semantic classification techniques discussed above, among others known in the art. In some embodiments, if sentence of the second speaker turn is correlated strongly to the sentence of the consecutive previous turn of the first speaker, the SC score is positive, or 1; if sentence of the second speaker turn is correlated inversely to the sentence of the consecutive previous turn of the first speaker, the SC score is negative, or −1; and otherwise, the SC score is rated as neutral or 0. In some embodiments, the step 206 is performed by the SCM 122. In some embodiments, the method 200 uses algorithmic techniques or statistical techniques without using an Al/ML model to determine the SC score between sentences of consecutive speaker turns in the conversation. In some embodiments, the method 200 uses Al/ML techniques to measure the SC score between sentences of consecutive speaker turns in the conversation.

At step 208, the method 200 determines an empathy score for the second speaker in the consecutive speaker turn pair based on the ST score and the SC score. In some embodiments, the empathy score is determined to be high (1) if the ST score is positive (1) and the SC score is positive (1), or if the ST score is neutral (0), and the SC score is positive (1). In some embodiments, the empathy score is determined to be neutral (0) if the ST score is positive (1), and the SC score is positive (0), or if the ST score is neutral (0) and the SC score is neutral (0), or if the ST score is negative (−1) and the SC score is positive (1). In some embodiments, the empathy score is determined to be negative (−1) in all other scenarios, and, for example, as described in Table 1. In some embodiments, the step 208 is performed by the empathy module 124. In some embodiments, the method 200 uses algorithmic techniques to determine tone, choice of words, and context to estimate a level of empathy to determine the empathy score. The method 200 proceeds to step 210 at which the method 200 ends.

Although the method 200 depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

While examples describe conversations between a seller and a customer, the techniques for determining empathy are applicable to any conversation between two or more persons, according to the embodiments described herein. While round numbers such as 1, 0 and −1 are used to depict the states of the ST score, SC score and empathy score, other fractional scores and associated states are contemplated herein, as would appear to those of ordinary skill without undue experimentation. Various steps of the method described herein may be performed using Al/ML techniques, non-AI/ML techniques, or a combination thereof, as known in the art.

While thresholds and other metrics may be described qualitatively or using one kind of measures, other known ways of measuring may be employed within the scope of the present invention. Although various methods discussed herein depict a particular sequence of operations, the sequence may be altered without departing from the scope of the present disclosure, unless otherwise apparent from the context. For example, some of the operations depicted may be performed in parallel or in a different sequence that does not materially affect the function of the methods discussed herein. In some embodiments, some of the steps performed in a method may be optional or omitted. In other examples, different components of an example device or apparatus that implements the methods may perform functions at substantially the same time or in a specific sequence.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. Other technical features may be readily apparent to one skilled in the art from the following figures, descriptions, and claims.

While the foregoing is directed to embodiments of the present invention, other and further embodiments of the invention may be devised without departing from the basic scope thereof.

I/We claim:

1. A computer implemented method for determining speaker effectiveness in conversations, the method comprising:
determining, at an analytics server, a sentiment transition (ST) score in a consecutive speaker turn pair in a conversation between a first speaker and a second speaker, wherein the ST score measures whether the sentiment transition from the first speaker to the second speaker is negative, neutral, or positive;
determining, at the analytics server, a semantic classification (SC) score in the speaker turn pair, wherein the SC score measures the relevance of utterances of the second speaker to the utterance of the first speaker; and
determining, at the analytics server, an empathy score for the second speaker in the speaker turn pair based on the ST score and the SC score.

2. The computer implemented method of claim 1, wherein the empathy score is determined to be high if the ST score is neutral or high, and the SC score is high.

3. The computer implemented method of claim 2, wherein the empathy score is determined to be neutral if the ST score is neutral or positive and the SC score is neutral, or if the ST score is negative and the SC score is positive.

4. The computer implemented method of claim 3, wherein the empathy score is determined to be negative if the empathy score is neither positive nor neutral.

5. The computer implemented method of claim 1, wherein the sentiment for at least one of the first speaker or the second speaker is determined based on at least one of: a transcript, tonal data, or video data of the utterance of the respective speaker.

6. The computer implemented method of claim 1, wherein determining at least one of: the sentiment, the ST score, the SC score, or the empathy score using an Artificial Intelligence and/or Machine Learning (AI/ML) model.

7. A computing apparatus comprising:
a processor; and
a memory storing instructions that, when executed by the processor, configure the apparatus to:
determine, at an analytics server, a sentiment transition (ST) score in a consecutive speaker turn pair in a conversation between a first speaker and a second speaker, wherein the ST score measures whether the sentiment transition from the first speaker to the second speaker is negative, neutral, or positive;
determine, at the analytics server, a semantic classification (SC) score in the speaker turn pair, wherein the SC score measures the relevance of utterances of the second speaker to the utterance of the first speaker; and
determine, at the analytics server, an empathy score for the second speaker in the speaker turn pair based on the ST score and the SC score.

8. The computing apparatus of claim 7, wherein the empathy score is determined to be high if the ST score is neutral or high, and the SC score is high.

9. The computing apparatus of claim 8, wherein the empathy score is determined to be neutral if the ST score is neutral or positive and the SC score is neutral, or if the ST score is negative and the SC score is positive.

10. The computing apparatus of claim 9, wherein the empathy score is determined to be negative if the empathy score is neither positive nor neutral.

11. The computing apparatus of claim 7, wherein the sentiment for at least one of the first speaker or the second speaker is determined based on at least one of: a transcript, a tonal data or a video data of the utterance of the respective speaker.

12. The computing apparatus of claim 7, wherein at least one of: the sentiment, the ST score, the SC score, or the empathy score is determined using an Artificial Intelligence and/or Machine Learning (AI/ML) model.

13. A non-transitory computer-readable storage medium, the computer-readable storage medium including instructions that when executed by a computer, cause the computer to:
determine, at an analytics server, a sentiment transition (ST) score in a consecutive speaker turn pair in a conversation between a first speaker and a second speaker, wherein the ST score measures whether the sentiment transition from the first speaker to the second speaker is negative, neutral, or positive;
determine, at the analytics server, a semantic classification (SC) score in the speaker turn pair, wherein the SC score measures the relevance of utterances of the second speaker to the utterance of the first speaker; and
determine, at the analytics server, an empathy score for the second speaker in the speaker turn pair based on the ST score and the SC score.

14. The computer-readable storage medium of claim 13, wherein the empathy score is determined to be high if the ST score is neutral or high, and the SC score is high, wherein the empathy score is determined to be neutral if the ST score is neutral or positive and the SC score is neutral, or if the ST score is negative and the SC score is positive, and wherein the empathy score is determined to be negative if the empathy score is neither positive nor neutral.

15. The computer-readable storage medium of claim 13, wherein the sentiment for at least one of the first speaker or the second speaker is determined based on at least one of: a transcript, tonal data, or video data of the utterance of the respective speaker.

16. The computer-readable storage medium of claim 13, wherein determining at least one of: the sentiment, the ST score, the SC score, or the empathy score using an Artificial Intelligence and/or Machine Learning (AI/ML) model.
